(19) United States
(12) Patent Application Publication
(10) Pub. No.: US 2017/0167526 A1
(43) Pub. Date: Jun. 15, 2017

(54) BOLT PROVIDED WITH LOCKING FUNCTION

(71) Applicant: Lock'n Bolt Corporation, Yokohama-shi, Kanagawa (JP)

(72) Inventor: Kenji Hasegawa, Yokohama-shi (JP)

(73) Assignee: Lock'n Bolt Corporation, Yokohama-shi, Kanagawa (JP)

(21) Appl. No.: 15/116,068

(22) PCT Filed: Jun. 2, 2014
(86) PCT No.: PCT/JP2014/064647

§ 371 Date: Aug. 2, 2016

(30) Foreign Application Priority Data
Feb. 6, 2014 (JP) 2014-021691

(51) Int. Cl. F16B 39/02

(52) U.S. Cl. CPC F16B 39/028

(57) ABSTRACT

A locking bolt that can reliably prevent loosening even when used at sites that experience severe temperature differences and severe vibration. The locking bolt (10) has a bolt main body (11), a diameter expanding member (31), and an auxiliary bolt (21). The diameter expanding member (31) is an inside the space (17) in the bolt main body (11) and has a truncated-circular-cone-shaped side surface (32) that comes into contact with the inner wall of the space (17) and expands the diameter of the space (17). The auxiliary bolt (21) is inserted into the axial hole (15) that is provided to the bolt main body (11), moves the diameter expanding member (31) in the direction in which the diameter of the space (17) in the bolt main body (11) is expanded, and imparts diameter expanding force to the space (17) in the bolt main body (11).

### TECHNICAL FIELD

The present invention relates to a bolt provided with a locking function (locking bolt).

### BACKGROUND ART

A male thread of a bolt and a female thread to be screwed with the male thread are screwed together through a spiral ridge/groove (spiral ridge and spiral groove) which are provided at the two threads. Rotation with respect to each other is stopped by the frictional force acting between the surfaces of the spiral ridge/groove whereby the fastened relationship is maintained. However, the frictional force generated between the spiral ridge/groove surfaces is only generated on smooth sloped surfaces, therefore there is the possibility that the sloped surfaces may slip relative to each other due to expansion/shrinkage, vibration, etc. caused by change of the temperature acting on the male thread and female thread over a long period, so the fastened condition between the male thread and the female thread may be broken resulting in loosening and detachment of the bolt.

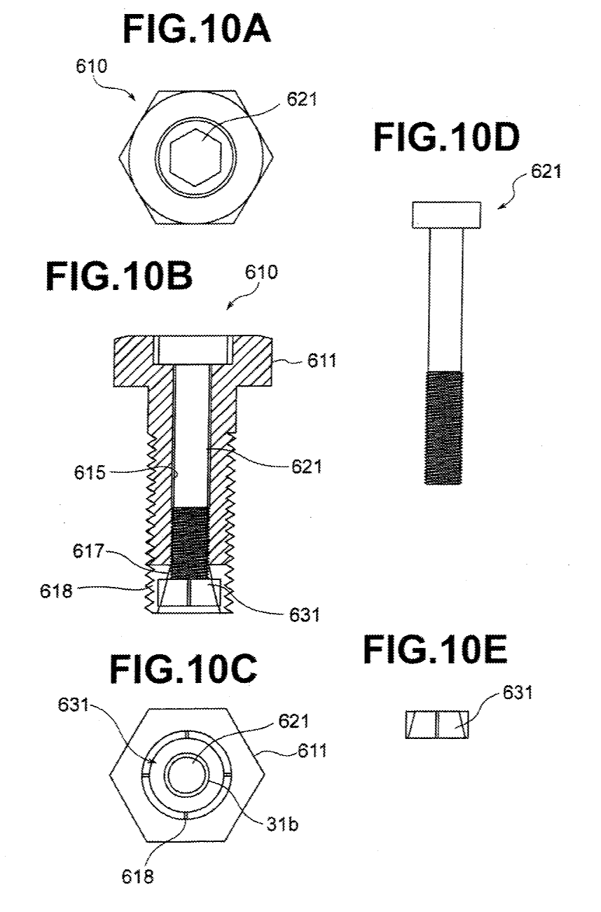

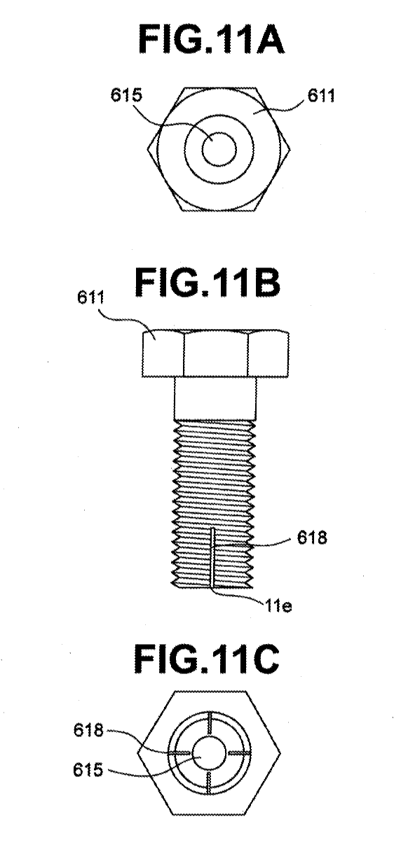

The present patent applicant has proposed a bolt provided with a locking function for preventing this type of disadvantage in PLT 1 (Japanese Patent Publication No. 2012-127494A). The locking bolt disclosed in PLT 1 will be explained with reference to FIGS. 10 and 11. A bolt 610 is configured by a bolt main body 611, an auxiliary bolt 621, and an expanding member 631. In the bolt main body 611, an axial bore 615 is formed in at least one end part of an axial center part thereof so that the end part of the axial bore 615 forms a truncated cone-shaped space 617 that is widened more the nearer to the distal end. In the end part of the shaft part having the truncated cone-shaped space 617 formed therein, one or more slits 618 are formed from the distal end (see FIG. 11). The expanding member 631 is arranged in the truncated cone-shaped space 617 of the bolt main body 611. It has a truncated cone-shaped side surface which abuts against the inner wall of the truncated cone-shaped space 617 and expands the space. The auxiliary bolt 621 is inserted in the axial bore 615 provided in the bolt main body 611. The bolt 610 is configured so as to move the expanding member 631 in a direction expanding the space of the bolt main body 611 and give an expanding force to the truncated cane-shaped space 617 of the bolt main body 611.

However, the bolt 610 is in a state where the one or more slits 618 provided in the truncated cone-shaped space 617 are just cut, that is, the widths of the front end portions and the rear end portions of the slits become almost the same, therefore a large torque becomes necessary for expanding the truncated cone-shaped space 617 resulting in a possibility that the expanding force will be insufficient and will not become a load sufficiently expanding the end part of the bolt main body 611 even if the expanding member 631 is pushed into the truncated cone-shaped space 617 through the auxiliary bolt 621, so the locking function by the expanding force will not sufficiently function.

Under this condition, as a means for sufficiently expanding the end part of the bolt main body 611 by the expanding force pushing the expanding member 631 into the truncated cone-shaped space 617 through the auxiliary bolt 621, the measure of increasing the number of slits and weakening an expanded force of the end part of the bolt main body may be considered. However, the increase of the number of slits conversely weakens a springback force of the end part of the bolt main body, therefore the locking function of the bolt does not sufficiently function. For example, depending on the thickness of the bolt shaft part, material, number of slits, thickness and material of the auxiliary bolt to be expanded, and the like, the bolt shaft part, particularly the slit base portion, may crack due to the expansion of diameter or the locking function may not exerted due to an insufficient expanding force or insufficient springback force etc.

### CITATION LIST

### Patent Literature

PLT 1: Japanese Patent Publication No. 2012-127494A

### SUMMARY OF INVENTION

An object of the present invention is to improve the bolts with the problems explained above and provide a loosening prevention bolt which can reliably stop loosening with a simple configuration and has a broad range of applicability.

Further, another object of the present invention is to provide a locking bolt which can reliably prevent loosening even if it is used in a place having a severe temperature difference or a place having severe vibration and has a broad range of applicability.

### Solution to Problem

A bolt of a first aspect of the present invention includes a bolt main body, an expanding member, and an auxiliary bolt. In the bolt main body, an axial bore is formed in at least one end part of an axial center part thereof so as to form a truncated cone-shaped space where the end part of the axial bore is widened more the nearer to the distal end. In the end part of the shaft part having the truncated cone-shaped space formed therein, one or more slits are formed in shapes with the same slit widths over predetermined lengths from the distal end and with widths of the bases (terminating parts) of the slits broader than the slit widths. The expanding member is arranged in the truncated cone-shaped space of the bolt main body. It has a truncated cone-shaped side surface which abuts against the inner wall of the truncated cone-shaped space and expands the space. The auxiliary bolt is inserted into the axial bore provided in the bolt main body, moves the expanding member in a direction expanding the space of the bolt main body, and gives an expanding force to the space of the bolt main body.

A bolt of a second aspect of the present invention includes a bolt main body, an expanding member, and an auxiliary bolt. In the bolt main body, an axial bore is formed in at least one end part of an axial center part thereof so as to form a truncated cone-shaped space where the end part of the axial bore is widened more the nearer to the distal end. In the end part of the shaft part having the truncated cone-shaped space formed therein, one or more slits are formed. The expanding member is screwed over the auxiliary bolt and is arranged in the truncated cone-shaped space of the bolt main body. The side surface of the expanding member is formed to a truncated cone-shaped side surface that abuts against the inner wall of the truncated cone-shaped space of the bolt main body and expands the truncated cone-shaped space. The auxiliary bolt is formed so that it is inserted into the axial bore provided in the bolt main body, moves the expanding member in a direction expanding the truncated cone-shaped space of the bolt main body, and gives an expanding force to the truncated cone-shaped space of the bolt main body. The length of the auxiliary bolt is a length by which the distal end of the spiral groove in the end part of the auxiliary bolt is exposed from the expanding member when inserting the auxiliary bolt into the axial bore provided in the bolt main body, moving the expanding member in the direction expanding the truncated cone-shaped space of the bolt main body, and giving an expanding force to the space of the bolt main body.

A bolt of a third aspect of the present invention includes a bolt main body, an expanding member, and an auxiliary bolt. In the bolt main body, an axial bore is formed in at least one end part of an axial center part thereof so as to form a truncated cane-shaped space where the end part of the axial bore is widened more the nearer to the distal end. In the end part of the shaft part having the truncated cone-shaped space formed therein, one or more slits are formed with the same slit widths over predetermined lengths from the distal end and with widths of the bases (terminating parts) of the slits broader than the slit widths. The auxiliary bolt is formed so that it is inserted into the axial bore provided in the bolt main body, moves the expanding member in the direction expanding the truncated cone-shaped space of the bolt main body, and gives an expanding force to the truncated cone-shaped space of the bolt main body. The expanding member is arranged in the truncated cone-shaped space of the bolt main body. It has a truncated cone-shaped side surface which abuts against the inner wall of the truncated cone-shaped space and expands the truncated cone-shaped space. The length of the auxiliary bolt is a length by which the distal end of the spiral groove in the end part of the auxiliary bolt is exposed from the expanding member when inserting the auxiliary bolt into the axial bore provided in the bolt main body, moving the expanding member in the direction expanding the truncated cone-shaped space of the bolt main body, and giving an expanding force to the space of the bolt main body.

Preferably, the expanding member is configured so as to be arranged in the truncated cone-shaped space of the bolt main body and so that the rotation of the shaft relative to the bolt main body is obstructed by a rotation prevention function.

Further, preferably, the expanding member is provided with a slit. More preferably, the slit is formed with the same slit width over a predetermined length from the distal end of the slit and with a width of the base (terminating part) of the slit broader than the slit width.

### Advantageous Effects of Invention

According to the bolt of the present invention, after fastening the male thread of the bolt with the female thread of a fastened object, the space in the rear end part of the bolt main body is enlarged by the expanding member, therefore the male thread is reliably strongly connected with the female thread, so the two threads will not be loosened even over a long term.

According to the bolt of the present invention, the shape of one or more slits provided in the end part of the shaft part having the truncated cone-shaped space formed therein is formed so as to have the same slit width over a predetermined length from the distal end and the width of the base (terminating part) of the slit broader than the slit width, therefore the springback force of the end part of the bolt main body can be accurately controlled, the fastening work becomes easy, and as a result the force expanding the truncated cone-shaped space by the expanding member is more reliably transmitted to the truncated cone-shaped space and the male thread is reliably strongly connected with the female thread. Accordingly, a bolt without loosening of the two threads even over a long term can be provided.

According to the present invention, by forming a bolt to a length by which the distal end of the spiral groove in the end part of the auxiliary bolt is exposed from the expanding member when inserting the auxiliary bolt into the axial bore provided in the bolt main body, moving the expanding member to the direction expanding the truncated cone-shaped space of the bolt main body, and giving an expanding force to the space of the bolt main body, the bolt is more strongly connected with the fastened object, thus a bolt which will not be loosened even over a long term can be provided.

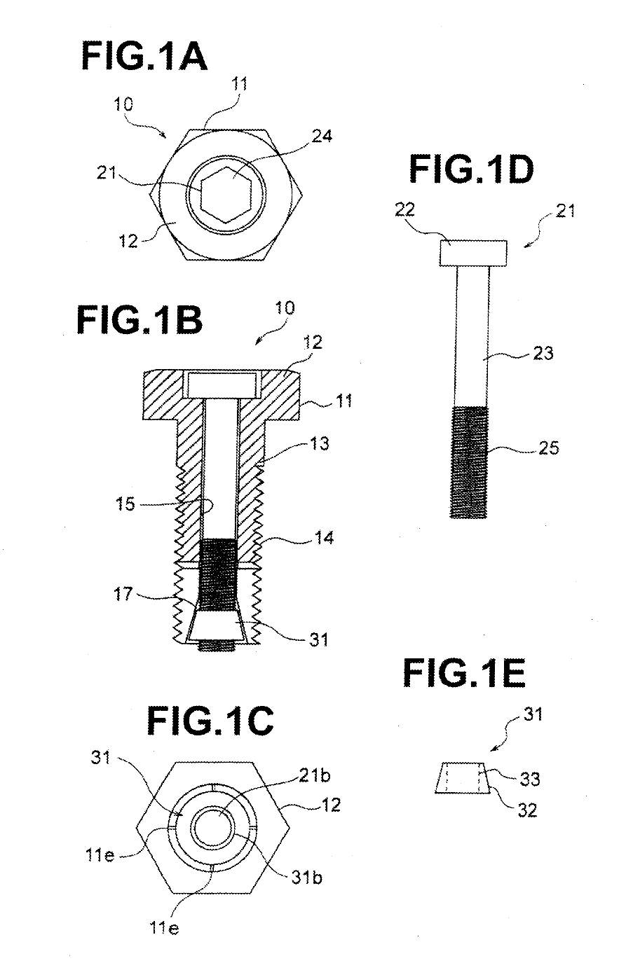

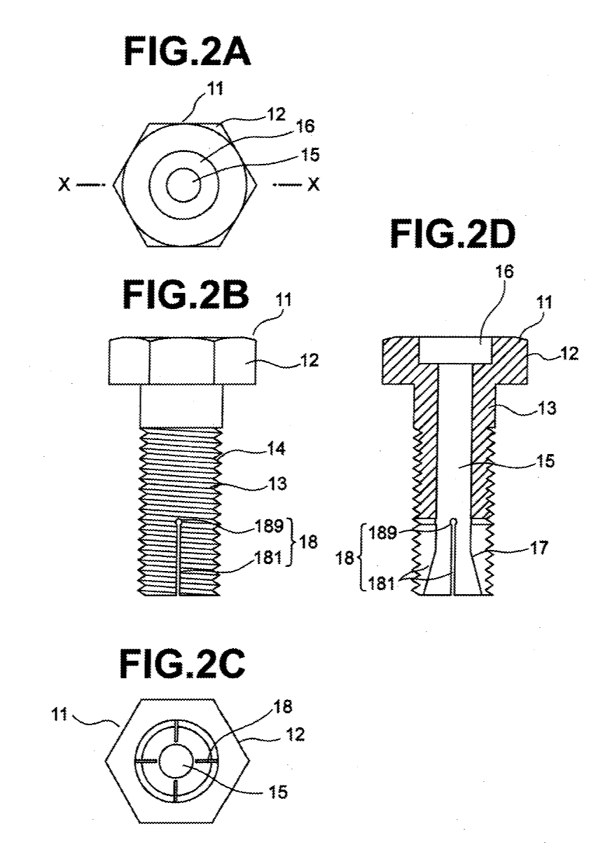

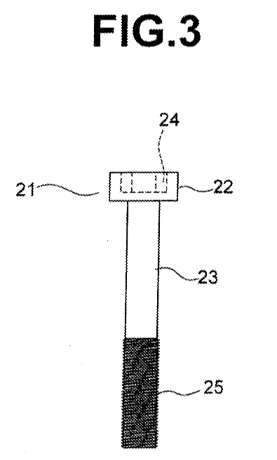

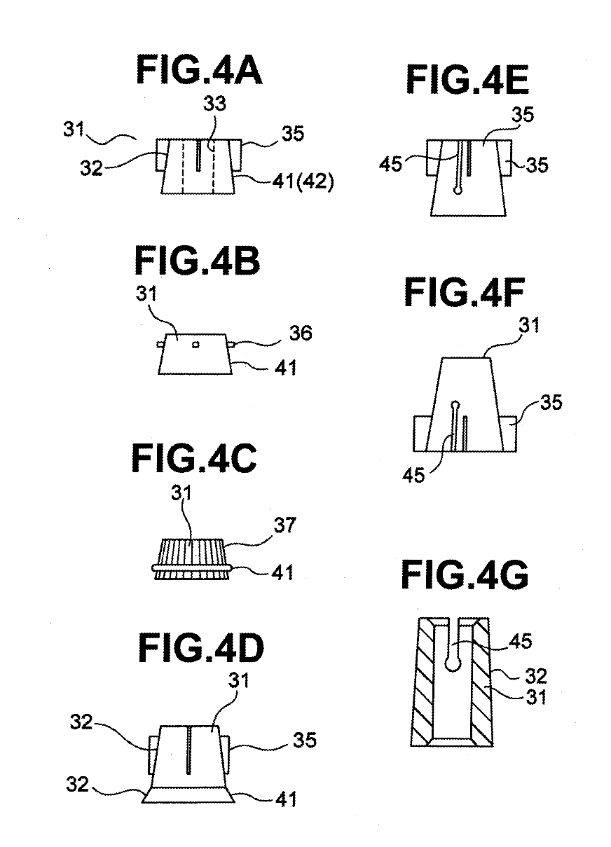

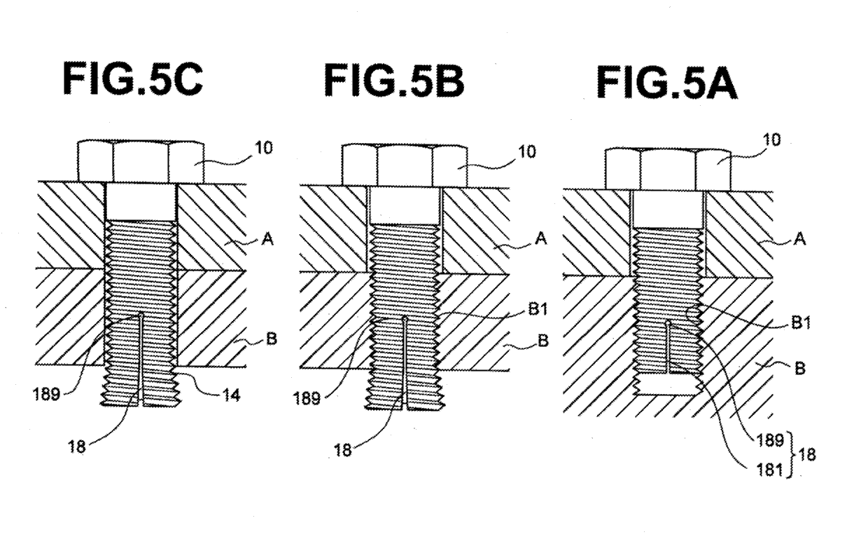

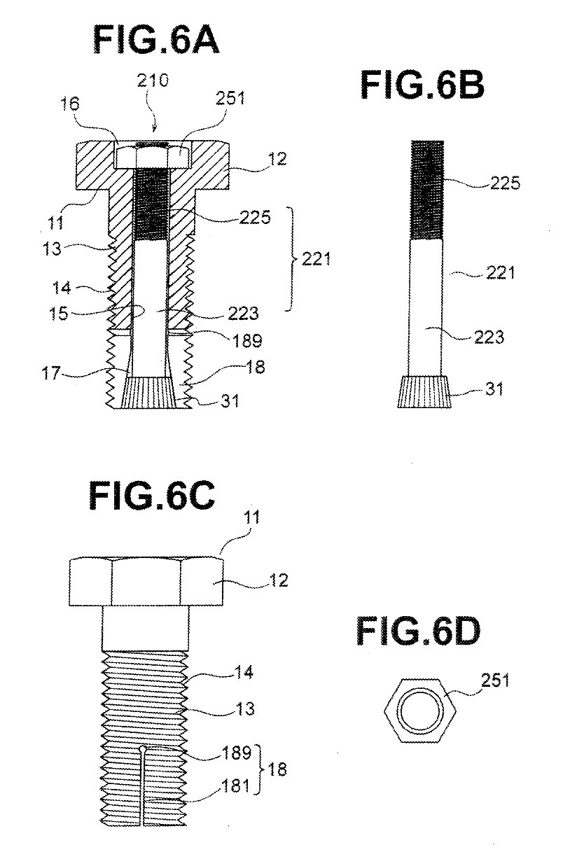

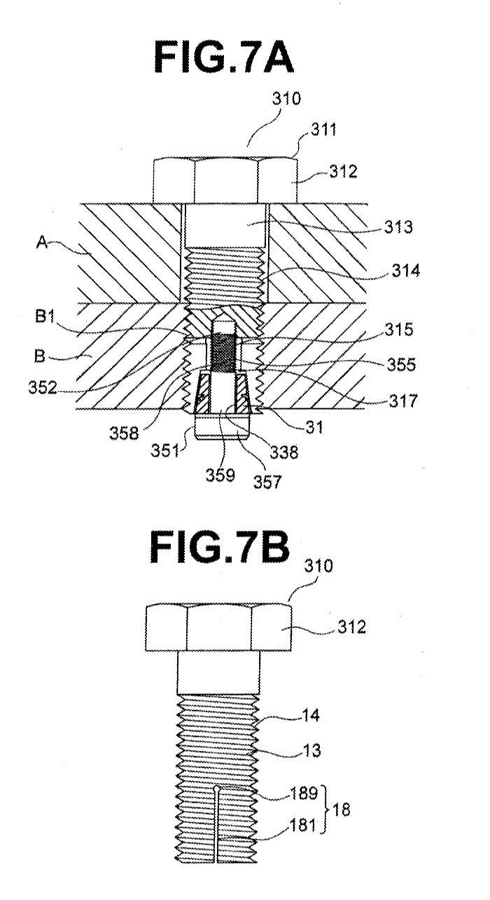

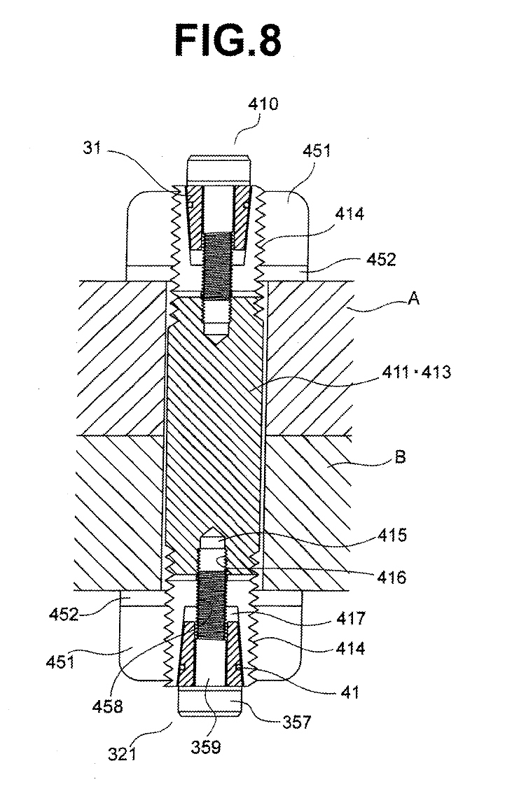

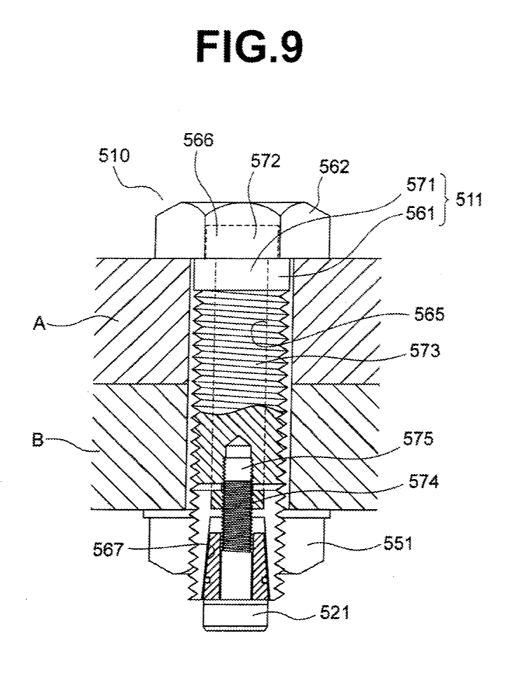

### BRIEF DESCRIPTION OF DRAWINGS

[FIGS. 1A to 1E] Views showing a bolt in a first embodiment of the present invention, in which FIG. 1A is a top view, FIG. 1B is a partially cutaway side view, FIG. 1C is a bottom view, FIG. 1D is a side view of an auxiliary bolt, and FIG. 1E is a side view of an expanding member.

[FIGS. 2A to 2D] Views showing a bolt main body in the first embodiment, in which FIG. 1A is a top view, FIG. 1B is a side view, FIG. 1C is a bottom view, and. FIG. 1D is a cross-sectional view taken along the X-X line in FIG. 1A.

[FIG. 3] A side view showing the auxiliary bolt in the first embodiment.

[FIGS. 4A to 4G] View showing expanding members.

[FIGS. 5A to 5C] Views showing a usage state when the bolt in the first embodiment is attached to a fastened object, in which FIG. 5A shows a state where the bolt is screwed with a closed bottom screw hole, FIG. 5B shows a state where the bolt is screwed with an open bottom screw hole, and FIG. 5C shows a state where the bolt is connected with the through holes of fastened objects which do not have threads.

[FIGS. 6A to 6D] Views showing a bolt in a second embodiment of the present invention, in which FIG. 6A is a partially cutaway side view, FIG. 6B is a side view, FIG. 6C is a side view of an auxiliary bolt, and FIG. 6D is a top view of a locking member comprised of a nut 251.

[FIGS. 7A and 7B] Views showing a bolt in a third embodiment of the present invention, in which FIG. 7A is a partially cutaway side view showing a state where the bolt is attached to the fastened objects and FIG. 7B is a side view.

[FIG. 8] A partially cutaway side view showing a bolt in a fourth embodiment of the present invention showing a state where the bolt is attached to the fastened objects.

[FIG. 9] A partially cutaway side view showing a bolt in a fifth embodiment of the present invention showing a state where the bolt is attached to the fastened objects.

[FIGS. 10A to 10E] Views showing a bolt in the prior art, in which FIG. 10A is a top view, FIG. 10B is a partially cutaway side view, FIG. 10C is a bottom view, FIG. 10D is a side view of an auxiliary bolt, and FIG. 10E is a side view of an expanding member.

[FIGS. 11A to 11C] Views showing a bolt main body in the prior art, in which FIG. 11A is a top view, FIG. 11B is a side view, and FIG. 11C is a bottom view.

### DESCRIPTION OF EMBODIMENTS

Below, embodiments of the present invention will be explained in detail with reference to the accompanying drawings.

### First Embodiment

FIGS. 1A to 1E to FIGS. 5A to 5C show a bolt 10 in a first embodiment of the present invention. The locking bolt of the present invention has (comprised of) the bolt 10 in the first embodiment includes (comprises) a bolt main body 11, an auxiliary bolt 21, and an expanding member 31. The expanding member 31 is a so-called “tip piece”.

Bolt Main Body

The bolt main body 11 is a head-fastening bolt configured by a hexagonal or circular head 12 and a columnar shaped shaft part 13 which is integrally formed with the head 12 as exemplified in FIGS. 1A to 1E. When the side surface of the head 12 forms a hexagon as exemplified, it becomes a tool engagement portion. If it forms a circular shape, the tool engagement portion is formed by forming a hexagonal recess 16 in the top surface of the head 12. Note that, in the illustration in FIGS. 2A to 2D, the side surface forms a hexagon and the recess 16 is formed in a circular shape. A spiral groove (male thread) 14 is cut in at least a front end portion of the outer circumferential surface of the shaft part 13. However, in a case where fastened objects provided with through holes are fastened as shown in FIG. 5C, the spiral groove can be omitted.

The axial center part of the bolt main body 11 is provided with the axial bore 15 receiving the auxiliary bolt 21. In the axial bore 15 in the direction of the head 12, a recess 16 which receives the head of the auxiliary bolt 21 so that it can rotate is formed. The end part of the axial bore 15 (opposite side to the head) is formed so as to become a space of a truncated cone shape (hereinafter referred to as a “truncated cone-shaped space”) 17 widened the further toward the distal end of the hole. The end part of the shaft part 13 having the truncated cone-shaped space 17 formed therein is provided with one or more slits 18 from the distal end thereof toward the head 12. The optimum number of slits is about two to four. However, four or more slits may be provided depending on the thickness of the bolt.

Each slit 18 provided in the truncated cone-shaped space 17 is formed by a slit portion 181 having the same width of slit and a widened portion 189. That is, in the slit 18, the slit portion 181 is cut with the same slit width over a predetermined length from the distal end of the bolt main body, while the base (terminating part) of the slit portion 181 is formed in a circular shape having a broader width than the slit width (widened portion 189). In the present embodiment, the widened portion 189 which is provided in the base of the slit 18 is shaped circularly as illustrated, and the diameter of the circle is set to 2 to 3 times the cut width. However, it is also possible to change the shape of the widened portion 189 to an oval or rectangle. The portion is suitably designed and selected according to the machining conditions, thickness of the bolt, and so on. The number of the slits 18 and the size of widening (ratio) are suitably designed considering the thickness and material etc. of the bolt.

In a bolt 610 in the prior art shown in FIGS. 10A to 10E, when the number of slits is decreased in order to maintain the elasticity at the time of expansion, depending on the thickness and material of the bolt shaft part, number of slits, thickness and material of the auxiliary bolt to be expanded, etc., there is the concern that a crack will be formed in the bolt shaft part, particularly the slit base portion, due to the expansion or that the locking function will not be exerted due to an insufficient expanding force or the like. In order to overcome such concerns, the embodiments of the present invention are configured so that the springback force (elasticity) of the bolt main body against the expansion of the front end portion is controlled by widening the base of the slit, a sufficient expansion is carried out with the expanding force by the expanding member 31, the size of the widened portion is controlled so that also the springback force of the bolt main body against the expansion is sufficient, and a locking effect is sufficiently achieved. That is, the bolts in the embodiments of the present invention are bolts capable of accurately controlling a resistance of the distal end of the bolt main body against the expanding force and suitably and easily controlling the locking effect by the number of the slits 18 and the size of the widened portion 189. By providing the widened portion 189 in the base of the slit 18, compared with the bolts in the prior art shown in FIGS. 10A to 10E and FIG. 11 not providing a widened portion, the bolts in the embodiments of the present invention become bolts wherein the locking effect is remarkably raised, that is, the locking effect is especially improved even if the tightening force of the expanding member 31 by the auxiliary bolt 21 is the same.

Auxiliary Bolt

As shown in FIGS. 1A to 1E and FIG. 3, the auxiliary bolt 21 includes (comprises) a locking head part 22 and a shaft part 23 which is formed integrally with the locking head part 22. The auxiliary bolt 21 is received in the axial bore 15 provided in the bolt main body 11 as shown in FIGS. 1A to 1E. When the auxiliary bolt 21 is received in the axial bore 15 of the bolt main body 11, the locking head part 22 is received inside the recess 16 provided in the head 12 of the bolt main body 11 so that it can turn. The locking head part 22 is formed in a shape whereby the tool for rotating the auxiliary bolt 21 can be locked. For example, when the recess 16 is circular, the side surface of the locking head part 22 forms a polygon (for example, hexagon). When the recess 16 is polygonal, a polygonal cavity, i.e., minus (−) or plus (+) groove is formed in the top face of the locking head part 22. In FIG. 3, a polygonal cavity 24 is indicated by a broken line. In the front end part of the shaft part 23 (opposite side to the head part 22), a thread 25 for connecting with the expanding member 31 which will be explained later is cut. The length of the fastening shaft part 23 of the auxiliary bolt 21 is preferably controlled to a length where several turns of the spiral groove in the end part of the shaft part 23 are exposed when screwing in the expanding member 31.

Expanding Member

The expanding member 31 is inserted into the truncated cone-shaped space 17 provided in the bolt main body 11 as shown in FIGS. 1A to 1E and is moved by the auxiliary bolt 21. At that time, it acts to spread the truncated cone-shaped space 17 of the bolt main body 11 outward. The expanding member 31 exhibits a truncated cone shape as shown in FIG. 1E and FIGS. 4A to 4G. The side surface 32 of the expanding member 31 is formed to a truncated cone trapezoidal shape where the apex of the cone is cut away so as to match with the inclination angle of the truncated cone-shaped space 17 provided in the bolt main body 11. The expanding member 31 may have a truncated cone-shaped portion in at least a portion and may expand the space 17 by this truncated cone-shaped side surface 32 solely abutting against the side surface of the truncated cone-shaped space 17. The expanding member 31 is screwed with the auxiliary bolt 21. In the present embodiment, a screw hole 33 (connecting hole) which is screwed with the thread 25 of the auxiliary bolt 21 is formed in the axial center part of the expanding member 31.

The expanding member 31 moves in the truncated cone-shaped space 17 due to the auxiliary bolt 21. At this time, the expanding member 31 moves due to the turning of the auxiliary bolt 21. However, if the shape of the expanding member 31 is as shown in FIG. 1E, sometimes frictional force does not act between the expanding member 31 and the truncated cone-shaped space 17, so the turning force of the auxiliary bolt is not transmitted to the expanding member 31 (spinning). At such a time, a rotation prevention function is provided on the truncated cone-shaped side surface 32 of the expanding member 31. For the rotation prevention function, provision is made of blades 35 to be fitted in the slits 18 provided in the bolt main body 11 as shown in FIG. 4A, or pins 36 as shown in FIG. 4B are provided. Otherwise, roulette machining 37 etc. as shown in FIG. 4C is applied for preventing rotation due to friction.

The rotation prevention function is provided at the expanding member 31 for obstructing the rotation of the expanding member 31 when the expanding member 31 which is screwed with the auxiliary bolt 21 is moved due turning of the auxiliary bolt 21. The mechanism for preventing the rotation of the expanding member 31 need only function to obstruct the rotation of the expanding member 31, therefore may be any configuration. In the present embodiment, the blades 35 are prepared as separate bodies. The blades 35 are fastened by fitting them in the slits extending in the axial direction formed in the side surface of the expanding member 31. The number of slits (number of blades 35) (or number of pins 36) is preferably made to match the one or more slits 18 to be provided in the bolt main body 11. When the length of the expanding member 31 (dimension in the axial direction) is made long, the ratio of the expansion with respect to the unit movement amount can be made small, the adjustment is easy, and a finer expansion (loosening prevention force) becomes possible. When desiring to obtain a large expansion range, the angle of the inclined surface of the expanding member 31 may be made large.

FIG. 4D is a view showing an embodiment in which the length of the expanding member 31 is made longer than those in the other embodiments and in which the side surface is inclined in two steps. The ratio of expansion with respect to the amount of movement of the expanding member 31 is determined according to the shape of the expanding member 31, particularly the angle of the truncated cone-shaped side surface 32. If the length (dimension in the axial direction) of the expanding member 31 is made long as shown in FIGS. 4D to 4G, the ratio f expansion with respect to the unit amount of movement can be made small. Further, when desiring to obtain a large expansion range, the inclination angle of the side surface of the expanding member 31 may be made large.

In this figure, the notation 41 indicates a friction member. The friction member 41 is, inserted so as to give a frictional force to the portion between the side surface of the expanding member 31 and the truncated cone-shaped space 17 so that the expanding member does not fall out due to a temperature change or vibration when the expanding member 31 is press-fit in the truncated cone-shaped space 17. This is attached according to need.

The expanding members 31 shown in FIGS. 4E to 4G are provided with slits 45 in a direction from the distal end (small-diameter end part) to the rear end (large-diameter end part). The widths of the slits 45 are uniform or the slit bases are formed broader than the slit widths. The expanding member 31 shown in FIG. 4E is provided with a slit 45 in the direction from the distal end (small-diameter end part) to the rear end (large-diameter end part). Further, the expanding member 31 shown in FIG. 4F is provided with a slit 45 in the direction from the rear end (large-diameter end part) to the distal end (small-diameter end part). The width of the slit is uniform, and the slit base is formed broader than the slit width. By providing the slit 45 in the expanding member 31 in this way, the inclination of the truncated cone-shaped space 17 provided in the bolt main body 11 and the inclination of the expanding member 31 end up coinciding easily, therefore the bolt main body 11 can be reliably fastened together with the fastened members, so the work efficiency is improved more.

Assembly of Bolt

The assembly of the bolt in the present embodiment will be specifically explained. As shown in FIGS. 1A to 1E, the auxiliary bolt 21 is inserted into the axial bore formed in the shaft part 13 of the bolt main body 11. The fastening shaft part 23 of the auxiliary bolt 21 is slidably inserted in the axial bore 15. The locking head part 22 integrally formed upon the upper end of the fastening shaft part 23 is received in the recess 15 of the bolt main body 11. Further, the expanding member 31 is screwed onto the distal end of the end part of the fastening shaft part 23 of the auxiliary bolt 21. The fastening shaft part 23 of the auxiliary bolt 21 is formed so as to have a length substantially the same as the length of the axial bore 15 of the bolt main body 11 or a bit longer than the latter, therefore the expanding member 31 is inserted from the lower end of the bolt main body 11 and thus the screw hole 33 of the expanding member 31 can be screwed with the thread 25 spirally provided on the shaft part 23 of the auxiliary bolt 21. The expanding member 31 is screwed with the shaft part 23 of the auxiliary bolt 21, moves upward (downward) following the turning of the auxiliary bolt 21, and thereby expands the width of the end part of the bolt main body. At this time, sometimes the expanding member 31 rotates following turning of the auxiliary bolt 21, therefore the expanding member 31 is not pulled up. In such case, for example provision is made of blades 35 in the expanding member and the blades 35 are fitted in the slits 18 provided in the lower end of the bolt main body 11. By fitting the blades 35 in the slits 18, when turning the auxiliary bolt 21 to pull up the expanding member 31, the expanding member 31 is obstructed in its rotation, then the expanding member 31 moves upward (downward) following the turning of the auxiliary bolt 21 and expands the width of the end part of the bolt main body.

In the auxiliary bolt 21, the locking head part 22 has a broader diameter than the axial bore 15. The fastening shaft part 23 extends from the center thereof. Accordingly, the locking head part 22 uses the bottom surface of the recess 16 of the bolt main body 11 as the bearing surface and functions as an abutting locking member and thereby generates a force pulling up the expanding member 31 screwed with the distal end of the end part of the fastening shaft part 23 through the shaft part 23. By inserting the auxiliary bolt 21 into the axial bore 15 of the bolt main body and rotating the auxiliary bolt 21 by a not shown tool in this way in the state where the expanding member 31 is screwed with the distal end of the end part of the shaft part 23 of the auxiliary bolt 21, the expanding member 31 is pulled up to the head part 22 direction, and thus the assembly of the bolt 10 is completed.

As explained above, the auxiliary bolt 21 is inserted in the axial bore 15 of the bolt main body, the auxiliary bolt 21 is rotated in the state where the expanding member 31 is screwed with the distal end of the end, part of the shaft part 23 of the auxiliary bolt 21, then the expanding member 31 is pulled up (temporarily locked). The bolt 10 is used as will be explained later in the same way as the usual bolt.

The bolt main body 11, auxiliary bolt 21, expanding member 31 in the present embodiment are preferably prepared from stainless steel or another metal. Other than this, it is also possible to prepare them by a hard plastic having a sufficient rigidity. The direction of the thread of the thread part 25 of the auxiliary bolt 21 is a general right-hand thread the same as the thread 14 of the bolt main body 11. However, there is no problem at all even if the thread is made a reverse direction.

Working (Operation) Condition

A case of fastening fastened objects by the bolt 10 in the present embodiment will be explained. FIG. 5A shows a state where two fastened objects A and B are fastened by the bolt 10 in the present embodiment. First, as explained before, the auxiliary bolt 21 is passed through the axial bore 15 of the bolt main body 11, the expanding member 31 is screwed with the front end part of the shaft part 23 and is temporarily tacked by gently fastening the thread, and therefore the bolt 10 is assembled. In this state, the distal end of the thread 14 of the bolt main body 11 does not swell outward in the diameter direction (does not expand) and maintains ordinary dimensions, so this can be handled in the same way as the usual bolt.

In order to connect the two fastened objects A and B by the assembled bolt 10, as shown in FIG. 5A, the bolt main body 11 is screwed into the thread B1 of the base side fastened object B in which a spiral groove to be screwed with the male thread 14 of the bolt main body 11 is cut. Here, although not shown, in principle, preferably a spring washer is used. At the time of screwing it in, the bolt 10 is fastened by a wrench or the like to make the lower portion of the head 12 of the bolt main body abut against the surface of the fastened object A, and the fastened objects A and B are fastened with a normal fastening strength.

Next, for locking, a not shown turning tool (for example hexagonal wrench) is made to abut against the head part 22 of the auxiliary bolt 21 and rotate the auxiliary bolt 21, thereby pulling up the expanding member 31 screwed with the distal end of the end part of the auxiliary bolt 21. When the expanding member 31 is pulled up to the side of the locking head part 22, the stress of the side surface 32 of the expanding member 31 is applied to the truncated cone-shaped space 17. The truncated cone-shaped space 17 is provided with the slits 18, therefore the space 17 expands outward, and thus the lower part of the shaft part 13 of the bolt main body 11 is expanded. By the expansion of the shaft part 13, the spiral groove (for example male thread) 14 is made to strongly abut against the thread (for example spiral groove) B1 of the fastened object B. Therefore, even when the bolt main body 11 is rotated in a detachment direction, the bolt 10 cannot be loosened by the power of the tool for rotating the head 12. Accordingly, as a result of the expanding member 31 expanding (widening) the distal end of the thread of the bolt main body 11 and exerting a strong locking effect, loosening of the bolt can be reliably prevented, therefore loosening of the connection between the bolt 10 and the fastened objects A and B and turning in the detachment direction will not occur.

In the present embodiment, the slit 18 to be provided in the truncated cone-shaped space 17 is formed with the same slit width over a predetermined length from the tip thereof, and the base (terminating part) of the slit is formed in a circular shape as a widened portion 189 having a shape broader than the slit width as illustrated. In this way, as a result of provision of the widened portion 189 in the base of the slit 18, compared with the bolt 610 in the prior art which is not provided with a widened portion as shown in. FIGS. 10A to 10E and FIGS. 11A to 11C, the locking effect remarkably rises, that is, the locking effect is remarkably improved even if the tightening force of the expanding member by the auxiliary bolt is the same as shown in Tables 1 and 2 which will be explained later.

### Second Embodiment

Assembly of Auxiliary Bolt and Bolt

A second embodiment of the bolt of the present invention will he explained with reference to FIGS. 6A to 6D. FIGS. 6A to 6D show a bolt 210 in the second embodiment, in which. FIG. 6A is a partially cutaway side view, FIG. 6B is a side view, FIG. 6C is a side view of an auxiliary bolt 221 to which an expanding member is attached, and FIG. 6D is a top view of the locking member comprised of the nut 251. The second embodiment is the same as the first embodiment except that the auxiliary bolt differs from the auxiliary bolt in the first embodiment, therefore the same notations will be attached to the same portions, and detailed explanations of them will be omitted. In the auxiliary bolt 221 in the second embodiment, a thread 225 is cut in the fastening shaft part 223, at least the front end part of the fastening shaft part 223, and the nut 251 is screwed with the thread 225. The expanding member 31 is provided at the rear end part of the fastening shaft part 223. Two of the fastening shaft part 223 and the expanding member 31 are integrally prepared or are separately prepared and attached by welding, bonding, screwing, or the like.

In the assembly of the bolt 210 in the second embodiment, into the axial bore 15 of the bolt main body 11, the thread 225 side of the fastening shaft part 223 formed by attaching the expanding member 31 to the rear end part of the fastening shaft part 223 is inserted from the side opposite to the head 12 of the bolt main body 11. The distal end thereof projects out into the recess 16 provided in the head 12 of the bolt main body 11. Next, the nut 251 is screwed to the distal end of the projected fastening shaft part 223 and distal end temporarily tacked, whereby the assembly is completed. Also, an assembly of a configuration screwing the fastening shaft part 223 and the nut 251 first, then attaching the expanding member 31 to the fastening shaft part is possible.

Using Method

In the bolt in the second embodiment as well, in the same way as the first embodiment, the fastened objects are screwed together by the bolt 210, then the nut 251 is fastened from the head 12 side of the bolt main body 11. By fastening the nut 251, the expanding member 31 is pulled up inside the space 17 in the distal end of the bolt main body 11. When the expanding member 31 is pulled up, the stress of the side surface 32 of the expanding member 31 is applied to the truncated cone-shaped space 17. The slit is formed from the distal end so as to have the same slit width over a predetermined length, and the widened portion 189 having a shape broader than the slit width is formed in the base (terminating part) of the slit, therefore the truncated cone-shaped space 17 is easily expanded outward, and the shaft part 13 of the bolt main body 11 is expanded. By the expansion of the shaft part 13, the spiral groove (male thread) 14 is strongly press-contacted with the fastened objects. Therefore, even when the bolt main body 11 is rotated in the detachment direction, the bolt 210 cannot be loosened by the power of the tool which rotates the head 12. In this way, as a result of exerting a strong locking effect by expanding (widening) the distal end of the shaft part of the bolt main body 11 by the expanding member 31, the loosening of the bolt can be reliably prevented.

In the locking bolt in the second embodiment, the space in the rear end of the shaft part of the bolt main body by which the fastened objects were screwed by the bolt was widened by the expanding member, the male thread was strongly connected with the female thread, and thereby the: fastened objects were strongly connected. However, a configuration as explained in the first embodiment (see FIGS. 5A to 5C) is also possible. In this, without providing threads at the shaft part of the bolt and the fastened objects, the bolt shaft is inserted into the through hole of the fastened objects, the space in the rear end part of the bolt main body is widened by the expanding member, the space in the rear end part of the bolt shaft is strongly joined with the through holes of the fastened objects, and thereby the fastened objects are connected. Further, by making the length of the bolt shaft longer than the length of the through holes of the fastened objects and thereby widening the space in the rear end part of the bolt main body by the expanding member and expanding the space in the rear portion, the portion of the bolt shaft which is exposed from the fastened objects becomes larger than the aperture of the through holes, that is, the expanded portion acts as a nut, and thus the fastened objects can be strongly connected.

### Third Embodiment

A bolt 310 in a third embodiment will be explained with reference to FIGS. 7A to 7B FIG. 7A is a partially cutaway side view showing a bolt 310 in the third embodiment, and FIG. 7B is a side view thereof.

Bolt Main Body

A bolt main body 311 in the third embodiment comprises an illustrated hexagonal or circular head 312 and a columnar-shaped shaft part 313 which is integrally formed with the head 312. If the side surface of the head 312 forms a hexagon as illustrated, it becomes a tool engagement portion. If it is circular, a not shown hexagonal groove or plus/minus groove is formed in the top surface of the head 312 thereby forming the tool engagement portion. The outer circumferential surface of the shaft part 313 exhibits a shape made to match with a fastening mechanism of the fastened objects. For example, as illustrated, a spiral groove (male thread) 314 is cut in the front end portion of the shaft part. Provision is made of an axial bore 315 (a closed bottom bore is shown in the figure, but it may be a through hole as well) which receives an auxiliary bolt 315 as will be explained later from the end part of the shaft part 313 on the side opposite to the head 312 toward the head. The end part of the axial bore 315 (opposite side to the head) is formed so as to form a space 317 having a truncated cone trapezoidal shape (hereinafter, referred to as a truncated cone shape) which is widened more the nearer to the distal end thereof. A thread 355 is cut continuing from the truncated cone-shaped space 317.

In the end part of the shaft part 313 of the bolt main body having the truncated cone-shaped space 317 formed therein, one or more slits are provided from the distal end thereof toward the body head portion 312. Each slit is formed with the same slit width over a predetermined length from the distal end and with a base (terminating part) of the slit becoming the widened portion 189 having a shape broader than the slit width.

Auxiliary Bolt

The auxiliary bolt 351, as shown in FIGS. 7A and 7B, comprises a locking head portion 357 and a shaft part 359 which is formed integrally with the locking head portion 357 and is provided with a thread 358 to be screwed with the thread 355 on at least the distal end. The auxiliary bolt 351 is received in the axial bore 315 provided in the bolt main body 311.

The shaft part 359 of the auxiliary bolt 351 is preferably designed so as to have a length a bit shorter than the length of the axial bore in the case where the shaft part 313 is closed bottom or schematically the same as or bit shorter than the latter in the case of a through-hole.

Expanding Member

The expanding member 31 is inserted in the truncated cone-shaped space 317 provided in the bolt main body 311 and is moved by the auxiliary bolt 351. At this time, it broadens the distal end of the thread 314 of the bolt main body 311 outward. A through hole 338 is provided in the center portion of the expanding member 31. The through hole 338 is formed in a size large enough to insert the auxiliary bolt 351 through itself. The rest of the configuration is the same as that shown in FIGS. 4A to 4G which was explained in the first embodiment, therefore a detailed explanation thereof will be omitted.

Assembly and Usage of Bolt

The assembly and usage of the bolt in the present embodiment will be specifically explained. The bolt main body 311 is inserted into the through holes of the fastened objects A and B as shown in FIGS. 7A and 7B. The shaft part 313 of the bolt main body 311 is designed so as to have a length almost the same as the length of the through holes of the fastened objects A and B. In FIGS. 7A and 7B showing the present embodiment, provision is made of a thread B1 on the inner circumferential wall of the through hole of the fastened object B. In the present embodiment, the head 312 of the bolt main body 311 is rotated by the tool and the bolt main body 311 is inserted into the through holes of the fastened objects A and B and thereby fasten the fastened objects A and. B. Next, the expanding member 31 is inserted into the fastening shaft part 359 of the auxiliary bolt 351, the expanding member 31 is fitted together with the auxiliary bolt 351 in the truncated cone-shaped space 317 provided in the bolt main body, and the auxiliary bolt 351 is fastened in the bolt main body 311 thereby moving the expanding member 31 to the interior of the space 317. At this time, if the expanding member 31 spins, for example the blades 35 (see FIGS. 4A to 4G) are set. The blades 35 are fitted in the slits 18 (see FIG. 2) provided in the lower end of the bolt main body 311.

By fitting the blades 35 in the slits 18, rotating the auxiliary bolt 351, and pulling the expanding member 31 into the bolt main body, the rotation of the expanding member 31 is obstructed, and the expanding member 31 moves following the turning of the auxiliary bolt 351.

As explained above, by inserting the auxiliary bolt 351 into the axial bore 315 of the bolt main body 311 and rotating the auxiliary bolt by a not shown tool, the expanding member 31 is pulled up in the head 312 direction. By elevation of the expanding member 31, the power which is applied to the truncated cone-shaped side surface of the expanding member 31 is applied to the direction expanding the truncated cone-shaped space 317 of the bolt main body, that is, spreads apart the front end portion of the shaft part 313 of the bolt main body 311 from the inside to the outer circumferential side. Since the base of the slit is provided with the widened portion 189, the tightening force of the expanding member by the auxiliary bolt is strongly transmitted to the front end portion of the shaft part, therefore the locking effect is especially improved.

### Fourth Embodiment

A locking bolt 410 in a fourth embodiment will be explained with reference to FIG. 8.

Bolt Main Body

The bolt in the fourth embodiment differs from the bolt main body 11 in the first embodiment in that a head is not formed in a bolt main body 411. The bolt comprises a columnar shaped shaft part 413 and threads 414 cut at the two end parts. At the two end parts, in the same way as the third embodiment, closed bottomed axial bores 415 are provided. These axial bores 415 may be through holes as well. The opened end parts of the axial bores 415 are formed in truncated cone-shaped spaces 417 in the same way as the first and third embodiments described before, and threads 458 are cut at the tips thereof. One car more slits (the slits are the same as the slits 18 shown in FIGS. 2A to 2D, therefore illustration is omitted) are provided from the distal end toward the center direction. The optimum number of slits is about 2 to 4. Nuts 451 which are to be screwed with the threads 414 are provided at the threads 414 in the two end parts of the bolt main body 411.

Auxiliary Bolt

The auxiliary bolt, as shown in FIG. 8, is given the same configuration as that of the auxiliary bolt 351 explained in the third embodiment. Further, the expanding member 31 is the same as that in the third embodiment, therefore the same notations will be attached and detailed explanations thereof will be omitted.

Using Method

FIG. 8 is a partially cross-sectional view of a state of usage of the bolt 410 in the fourth embodiment. The bolt main body 411 is passed through the through holes of the fastened objects A and B. At this time, a state is exhibited where the two end parts of the bolt main body 411 (the two end parts provided with the threads 414) are projected from the surfaces of the fastened objects A and B to almost the same extents. On the threads 414 of the projecting end parts of the bolt main body 411, nuts 451 having the spiral grooves to be screwed with the threads 414 on their inner circumferential surfaces are mounted through washers 452 thereby fixing the fastened objects A and B by fastening. Next, into the truncated cone-shaped spaces 417 on the two ends of the bolt main body 411, expanding members 31 (for example ones having the same shape as that in FIG. 4F) are inserted from the outside, the auxiliary bolts 351 are inserted through the communicating holes of the expanding members 31, and the auxiliary bolts 351 are rotated by the tool etc.

When making the auxiliary bolts 351 rotate and screwing them into the axial bores 415, in the same way as the first embodiment etc., the expanding members 31 engage make the blades etc. of the rotation prevention mechanism engage with not shown slits in the bolt main body according to need. The expanding members 31 are pushed by the auxiliary bolts 351 and move inward inside the truncated cane-shaped spaces 417. For this reason, the end parts of the bolt main body 411 are expanded and are strongly pushed against the inner circumferential walls of the nuts 451, whereby the two are strongly connected. The bolt in the fourth embodiment, as shown in FIG. 8, is particularly effective when applied to the fastened objects A and B having through holes larger than the outer diameter of the bolt main body 411.

### Fifth Embodiment

A loosening prevention bolt 510 in a fifth embodiment will be explained with reference to FIG. 9.

Bolt Main Body

A bolt main body 511 in the fifth embodiment comprises a bolt main part 561 which is schematically the same as the bolt main body 11 explained in the first embodiment and an auxiliary bolt 571 which is head inserted into an axial bore 565 of the bolt main part 561. A recess 566 is formed in a head 562 of the bolt main part 561 and is formed so that the head 572 of the auxiliary bolt 571 is received and therefore rotation is impossible. The auxiliary bolt 571 comprises the head 572 and a shaft part 573. The front end portion of the shaft part 573 is provided with an axial bore 575. A thread 574 is provided in the axial bore 575. The shaft part 573 is designed so as to have a length shorter than the length of the bolt main part 561, but long enough to exert the function of the expanding member 31 which will be explained later.

The recess 566 which is provided in the head 562 of the bolt main part 561 is formed so as to receive a head 572 of the auxiliary bolt 571 and obstruct the rotation of the head 572. For example, if the head 562 of the bolt main part 561 is formed in a hexagon, the recess 566 is formed in a hexagon so as to match with the shape of the former. This is formed so s to receive the head 572 of the auxiliary bolt so that it cannot rotate when the auxiliary bolt 571 is inserted in the axial bore 565 of the bolt main part 561. The recess 566 to be provided in the head is satisfactory so far as its shape is large enough to accommodate the bolt main part 561 so that it cannot rotate, therefore the shape etc. thereof are optional. The auxiliary bolt 521 is the same as the auxiliary bolt 351 explained in the third embodiment. Also the expanding member 31 and nut 551 are also the same as those in the embodiments described before.

Using Method

First, the bolt main part 561 is inserted into the through holes of the fastened objects A and B. Next, the nut 551 is screwed with the distal end of the shaft part 563 of the bolt main part 561 projecting from the fastened object, then the nut 551 is tightened to thereby fasten the fastened objects A and B. The auxiliary bolt 571 is inserted into the axial bore 565 of the bolt main part 561 in this state. It is inserted so that the head 572 of the auxiliary bolt 571 is received in the recess 566 of the bolt main part 561.

Then, into the rear end of the auxiliary bolt 571, the auxiliary bolt 521 having the expanding member 31 inserted therein is inserted into the truncated cone-shaped space 567 of the bolt main part 561 so that the expanding member 31 (for example one having the same shape as that in FIG. 4F) is received, then the auxiliary bolt 571 is rotated by a tool etc. By making the auxiliary bolt 571 rotate to screw it into the axial bore 575, the expanding member 31 is pushed by the locking head of the auxiliary bolt 521 and moves inward inside the truncated cone-shaped space 567. For this reason, the end part of the bolt main body 511 is strongly pressed against the inner circumferential wall of the nut 551, and thus the two are strongly connected. Also the bolt in the fifth embodiment is, as shown in FIG. 9, effective particularly when applied to fastened objects A and B having through holes larger than the outer diameter of the bolt main body 511.

In the locking bolts in the fourth and fifth embodiments, configurations were explained where the bolt main bodies 411 and 511 and the nuts 451 and 551 were used to connect the fastened objects, then the rear end part spaces of the bolt main bodies were expanded by the expanding members and the male threads were strongly connected to the nuts. However, without providing the nut 451, by spreading apart the space in the end part of the bolt main body by the expanding member to expand the space in the end part to be larger than the aperture of the through holes of the fastened objects, as explained in FIG. 5C for the first embodiment, it no longer becomes possible to pull out the shaft part of the bolt from the through holes of the fastened objects. As a result, the fastened objects can be fastened.

### Sixth Embodiment

A bolt in a sixth embodiment will be explained with reference to FIGS. 1A to 1E to FIG. 3 and FIGS. 10A to 10E. The bolt in the sixth embodiment is, as shown in FIGS. 1A to 1E, a bolt comprising a bolt main body 11, an expanding member 31, and an auxiliary bolt 21. The auxiliary bolt 21 is formed as shown in FIGS. 1A to 1E so as to have a length by which several turns of the distal end 27 of the spiral groove in the end part of the auxiliary bolt 21 are exposed from the expanding member at the time when the auxiliary bolt 21 is inserted into the axial bore 15 provided in the bolt main body 11, the expanding member 31 is moved in the direction expanding the truncated cone-shaped space 17 of the bolt main body, and an expanding force is given to the space of the bolt main body 11. In the present embodiment, a widened portion is not formed in the base (terminating part) of a slit provided in the bolt main body (see FIG. 10). The rest of the configuration is the same as that in the first embodiment, therefore a detailed explanation will be omitted.

If the auxiliary bolt 21 is formed so as to have a length by which several turns of the distal end 27 of the spiral groove in the end part are exposed from the expanding member in this way, a larger loosening force after fastening the bolt with the fastened objects becomes necessary, and the locking effect is especially improved, though the reason for that is not clear.

### Seventh Embodiment

A seventh embodiment of the present invention will be explained with reference to FIGS. 1A to 1E to FIG. 3. A bolt in the seventh embodiment is, as shown in FIGS. 1A to 1E, a bolt comprising a bolt main body 11, an expanding member 31, and an auxiliary bolt 21. The auxiliary bolt 21 is formed as shown in. FIGS. 1A to 1E so as to have a length by which several turns of the distal end 17 of the spiral groove in the end part of the auxiliary bolt 21 are exposed from the expanding member when the auxiliary bolt 21 is inserted into the axial bore 15 provided in the bolt main body, the expanding member 31 is moved to the direction expanding the diameter of the truncated cone-shaped space 17 of the bolt main body, and an expanding force is given to the space of the bolt main body 11. In the present embodiment, as widened portion is formed in the base (terminating part) of each slit provided in the bolt main body. The rest of the configuration is the same as that in the first embodiment, therefore a detailed explanation will be omitted.

If the auxiliary bolt 21 is formed so as to have a length by which several turns of the distal end 27 of the spiral in the end part are exposed from the expanding member in this way, a larger detachment power (loosening force) after fastening the bolt with the fastened objects becomes necessary, and the locking effect is especially improved.

Next, an experiment on the locking effect was carried out for the bolt in the first embodiment, the bolt in the seventh embodiment, a conventional standard bolt which is not provided with a truncated cone-shaped space, and the bolts in the prior art shown an FIGS. 10A to 10E and FIGS. 11E to 11C. These bolts were all comprised of SUS. In the experiment, the bolt main bodies were fastened with the fastened objects with, a constant power, then the auxiliary bolts were (a) fastened at 5 N/m for bolts having a bolt diameter of 12 mm and (b) fastened at 2.5 N/m for bolts having a bolt diameter of 8 mm. Vibration was given under the following severe conditions, then the expanding members were removed and the loosening forces (detachment powers) when detaching the bolts were measured. The results will be shown in Table 1. The comparative example shows the bolts having the same slit widths shown in FIGS. 10A to 10E and FIGS. 11A to 11C. The standard bolts (conventional examples) are bolts which are not provided with truncated cone-shaped spaces.

Experimental Conditions

| | | |
|---|---|---|
| Vibration number (frequency) | 30 | Hz |
| Amplitude (degree of acceleration) | 20 | G |
| Duration | 17 | minutes |

TABLE 1

| | Tightening | Tightening force | Loosening |
|---|---|---|---|
| | force of bolt | of auxiliary bolt | force |
| Type of bolt | | | |
| (12 mm × 35 mm) | | | |
| Standard bolt | 40 (N/m) | — (N/m) | 27 (N/m) |
| (conventional example) | | | |
| First embodiment | 40 (N/m) | 5 (N/m) | 45 (N/m) |
| Seventh embodiment | 40 (N/m) | 5 (N/m) | 48 (N/m) |
| Comparative example | 40 (N/m) | 5 (N/m) | 41 (N/m) |
| Type of bolt | | | |
| (8 mm × 20 mm) | | | |
| Standard bolt | 17 (N/m) | — (N/m) | 13 (N/m) |
| (conventional example) | | | |
| First embodiment | 17 (N/m) | 2.5 (N/m) | 24 (N/m) |
| Seventh embodiment | 17 (N/m) | 2.5 (N/m) | 26 (N/m) |
| Comparative Example | 17 (N/m) | 2.5 (N/m) | 20 (N/m) |

As shown in Table 1, the standard bolt having a bolt diameter of 12 mm and a length of 35 mm had been already loosened in the vibration experiment, and the loosening force was 27 N/m. Contrary to this, a locking effect such as 41 N/m was exerted in the bolt in the prior art, but the bolts in the first and seventh embodiments of the present invention showed locking effects such as 45 N/m and 48 N/m which were more excellent than that in the comparative example. The bolt in the seventh embodiment shows more excellent effect than the bolt in the first embodiment. Also, for thin bolts having a bolt diameter of 8 m and a length of 20 mm, the standard bolt has been already loosened in the vibration experiment, the locking effect such as 20 N/m is exerted in the bolt in the prior art, the bolts in the first and seventh embodiments show more excellent locking effects such as 24 N/m and 26 N/m than the bolt in the prior art. They show the effects of the same tendency as that of the bolt having a bolt diameter of 12 mm.

In this way, by providing the widened portion in the slit base, the locking effect of the bolts was conspicuously improved. The reason for this is guessed to be that the springback force of the bolt main body in the widened portion was maintained although the expanding force of the expansion portion was weakened by the widened portion of the: slit base, the expanding force by the expanding member was sufficiently transmitted to the widened portion, it could not return since the returning power of the widened portion was obstructed by the expanding member, and therefore the force of maintaining the expansion state was weakened.

In the bolts in the prior art shown in FIGS. 10A to 10E and FIG. 11, the strength of the expansion portion greatly differs according to the number of slits. It can be considered that if the number is small, the strength is large and the force of the expanding member does not sufficiently act, while if the number is too large, the springback force of the widened portion becomes weak. In any case, the locking effect is no longer exhibited. Further, the base of the slit cracks due to excessive tightening force which is applied at the time of expansion according to some material, therefore the lacking effect is weakened. In contrast to such consideration, by providing the widened portion 189 in the base as explained above, the strength of the widened portion can be controlled without increasing the number of slits resulting in a bolt without concerns explained above, facilitating the work, and reliably exhibiting the locking effect. That is, the force expanding the truncated cone-shaped space by the expanding member is reliably transmitted by the space, and the male thread is reliably strongly connected with the female thread, therefore the resultant bolt will not be loosened between the two even over the long term.

In the present embodiment, it is also possible to rotate the auxiliary bolt 21 in an opposite direction to the fastening and remove it away after raising the expanding member 31 by the auxiliary bolt 21 and fixing the expanding member 31 in the truncated cone-shaped space 17 of the bolt main body. That is, by rotating the auxiliary bolt 21 in the direction opposite to the direction fastening the expanding member 31, the auxiliary bolt 21 can be separated from the expanding member 31. Even if the auxiliary bolt 21 is withdrawn from the expanding member 31, the expanding member 31 is fixed to the bolt main body, therefore there is no obstruction in the locking function of the bolt. By removing the bolt in this way, the auxiliary bolt is eliminated from the bolt, therefore the effect is also exhibited that the worker can prevent unfastening of the auxiliary bolt in advance.

The bolt in the embodiment shown in FIG. 5B shows a case where the hole having the thread B1 provided in the fastened object B becomes a through hole. The assembly of the bolt and screwing of it with the fastened objects are the same as those in the case of FIG. 5A. In FIG. 5B, the distal end of the end part of the shaft part 13 of the bolt main body 11 projects out from the fastened object B. Accordingly, when the expanding member 31 is pulled up, the front end part of the bolt main body 11 expands to form a state where the distal end of the bolt penetrating through the fastened objects opens up and therefore a stronger loosening prevention effect is obtained. In the case of usage aimed at a through type screw hole, a more suitable locking effect is obtained if use is made of the expanding member 31 having the shape shown in FIG. 4F.

That is, in the expanding member 31 in FIG. 4F, for example, after a lower bottom portion of a truncated cone from which a top part of a cone with an apex angle of for example 8 degrees is removed, for example, an upper bottom portion of a truncated cone from which a top part of a cone with an apex angle of for example 30 degrees is removed is formed. The blades 35 are fastened to the main body part of the truncated cone shape of the side surface (the angle drawn exaggerated in the diagram). By giving steps in inclination in this way and expanding the distal end of the bolt with a larger angle, the locking effect is further improved. By configuring the bolt in this way, also the excellent effect is exhibited that when attachment of a nut from the back side would be difficult, strong screwing becomes possible without using a nut.

In the embodiments explained above, the tool engagement portion of the auxiliary bolt 21 was configured so that the periphery of the locking head part 22 of the auxiliary bolt 21 was formed in a hexagonal shape so that it could be turned by a wrench or the like. However, naturally, it may be a hexagonally shaped cavity or minus or plus groove capable of insertion of a minus or plus screwdriver. In any case, naturally, the tool engagement portion may have any shape so far as it has a configuration capable of turning the auxiliary bolt 21. Further, also for the bolt main body 11, the tool engagement portion turning this may have a shape other than a hexagonal shape as well.

In the locking bolt in the embodiments described before, after fastening the male thread of the bolt with the female threads of the fastened objects, the space in the rear end part of the bolt main body was spread apart by the expanding member, and the male thread was strongly connected with the female threads thereby strongly connecting the fastened objects. However, it may be configured as shown in FIG. 5B as well, wherein the fastened objects are not provided with female threads, the length of the bolt shaft part 13 is made longer than the length of the through holes of the fastened objects A and B, and the space 17 in the rear end part of the bolt main body 11 is spread apart by the expanding member 31 to expand the space in the rear part, thereby expanding the portion of the bolt shaft part 13 which is exposed from the fastened object B to become larger than the aperture of the through holes and thereby strongly connecting the fastened objects. That is, it can be configured so as to add the role of the nut to the expanded portion as well. In this embodiment, the shaft part 13 of the bolt main body is provided with the thread 14. However, for example, in the usage method as shown in the example in FIG. 5C, a configuration not provided with a thread 14 is also possible.

The locking bolts in the embodiments of the present invention are locking bolts having a wide working range capable of reliably preventing loosening even if they are used in places where the temperature greatly changes or places with vigorous vibration.

### REFERENCE SIGNS LIST

10, 210, 310, 410, 510 . . . bolts
11, 311, 411, 511, 561 . . . bolt main bodies
12, 22, 312, 572 . . . heads
13, 23, 223, 313, 359, 563, 573 . . . shaft parts
14, 25, 225, 314, 355, 358, 414, 416, 574 . . . threads
15, 315, 415, 575, 565 . . . axial bores
17, 317, 417, 565 . . . truncated cone-shaped spaces
18, 45 . . . slits
189 . . . widened portion
21, 221, 351, 521, 571 . . . auxiliary bolts
31 . . . expanding member
32 . . . truncated cone-shaped side surface
251, 451, 551 . . . nuts
357 . . . locking head

1-7. (canceled)

8. A bolt (10) comprising a bolt maid body (11), an expanding member (31), and an auxiliary bolt (21), wherein
the bolt main body (11) is provided with an axial bore (15) in at least one end part of its axial center part so as to form a truncated cone-shaped space (17) where the end part of the axial bore is widened more the nearer to the distal end,
in the end part of the shaft part (13) having the truncated cone-shaped space (17) formed therein, one or more slits (18) are formed in a circumferential direction with the same slit widths over predetermined lengths from the distal end and with widths of the bases (terminating parts) of the slits broader than the slit widths,
the expanding member (31) is arranged in the truncated cone-shaped space (17) of the bolt main body and has a truncated cone-shaped side surface (32) which abuts against the inner wall of the truncated cone-shaped space and expands the truncated cone-shaped space,
the auxiliary bolt (21) is inserted into the axial bore (15) provided in the bolt main body (11), moves the expanding member (31) in a direction of expanding the truncated cone-shaped space (17) of the bolt main body (11), and gives an expanding force to the truncated cone-shaped space (17) of the bolt main body (11), and
the auxiliary bolt (21) is inserted into the axial bore (15) provided in the bolt main body (11), the expanding member (31) is moved in the direction expanding the diameter of the truncated cone-shaped space (17) of the bolt main body (11), and thereby giving an expanding force to the truncated cone-shaped space (17) of the bolt main body (11).

9. A bolt comprising a bolt main body, an expanding member, and an auxiliary bolt, wherein
the bolt main body is provided with an axial bore in at least one end part of its axial center part formed so as to have such truncated cone-shaped space where the end part of the axial bore is widened more the nearer to the distal end,
one or more slits are formed in a circumferential direction in the end part of the shaft part having the truncated cone-shaped space formed therein,
the expanding member is screwed to the auxiliary bolt and is arranged in the truncated cone-shaped space of the bolt main body, the side surface of the expanding member is formed to a truncated cone-shaped side surface that abuts against the inner wall of the truncated cone-shaped space of the boll main body and expands the space, and
the auxiliary bolt is formed so that it is inserted into the axial bore provided in the bolt main body, moves the expanding member in a direction expanding the diameter of the truncated cone-shaped space of the bolt main body, and gives an expanding force to the truncated cone-shaped space of the bolt main body, and
the length of the auxiliary bolt is a length by which several turns of the distal end of the spiral groove in the end part of the auxiliary bolt are exposed from the expanding member at the time when the auxiliary boll is inserted into the axial bore provided in the boll main body, the expanding member is moved to the direction expanding the truncated cone-shaped space of the bolt main body, and an expanding force is given to the truncated cone-shaped space of the bolt main body.

10. A bolt comprising a bolt main body, an auxiliary bolt, and an expanding member, wherein
the bolt main body is provided with an axial bore in at least one end part of its axial center part formed so as to have a truncated cone-shaped space where the end part of the axial bore is widened more the nearer to the distal end,
one or more slits are formed in a circumferential direction in the end part of the shaft part having the truncated cone-shaped space formed therein with the same slit widths over predetermined lengths from the distal end and with widths of the bases (terminating parts) of the slits broader than the slit widths,
the auxiliary bolt is formed so that it is inserted into the axial bore provided in the bolt main body, moves the expanding member in the direction, expanding the diameter of the truncated cone-shaped space of the bolt main body, and gives an expanding force to the truncated cone-shaped space of the bolt main body,
the expanding member is arranged in the truncated cone-shaped space of the boll main body and has a truncated cone-shaped side surface which abuts against the inner wall of the space and expands the truncated cone-shaped space, and
the length of the auxiliary bolt is a length by which several turns of the distal end of the spiral groove in the end part of the auxiliary bolt are exposed from the expanding member at the time when the auxiliary bolt is inserted into the axial bore provided in the bolt main body, the expanding member is moved to the direction expanding the diameter of the truncated cone-shaped space of the bolt main body, and an expanding force is given to the truncated cone-shaped space of the bolt main body.

11. The bolt according to claim 8, wherein:
the bolt main body comprises a bolt main part and auxiliary bolt, the bolt main part is formed so that the axial bore is provided in its axial center part to form a truncated cone-shaped space where the end part of the axial bore is widened more the nearer to the distal end,
one or more slits are formed in a circumferential direction in the end part of the shaft part having the truncated cone-shaped space formed therein with the same slit widths over predetermined lengths from the distal end and with widths of the bases (terminating parts) of the slits broader than the slit widths,
the auxiliary bolt is inserted into the axial bore of the bolt main part so that it cannot rotate, and
a thread for screwing the auxiliary bolt having the expanding member attached thereto is provided in the end part of the auxiliary bolt.

12. The bolt according to claim 9, wherein:
the bolt main body comprises a bolt main part and auxiliary bolt, the bolt main part is formed so that the axial bore is provided in its axial center part to form a truncated cone-shaped space Where the end part of the axial bore is widened more the nearer to the distal end,
one or more slits are formed in a circumferential direction in the end part of the shaft part having the truncated cone-shaped space formed therein with the same slit widths over predetermined lengths from the distal end and with widths of the bases (terminating parts) of the slits broader than the slit widths,
the auxiliary bolt is inserted into the axial bore of the bolt main part so that t cannot rotate, and
a thread for screwing the auxiliary bolt having the expanding member attached thereto is provided in the end part of the auxiliary bolt.

13. The bolt according to claim 10, wherein:
the bolt main body comprises a bolt main part and auxiliary bolt, the bolt main part is formed so that the axial bore is provided in its axial center part to form a truncated cone-shaped space where the end part of the axial bore is widened more the nearer to the distal end,
one or more slits are formed in a circumferential, direction in the end part of the shaft part having the truncated cone-shaped space formed therein with the same slit widths over predetermined lengths from the distal end and with widths of the bases (terminating parts) of the slits broader than the slit widths,
the auxiliary bolt is inserted into the axial bore of the boll main part so that it cannot rotate, and
a thread for screwing the auxiliary bolt having the expanding member attached thereto is provided in the end part of the auxiliary bolt.

14. The bolt according to claim 8, wherein the expanding member is configured arranged in the truncated cone-shaped space of the bolt main body and so that rotation of the shaft relative to the bolt main body is prevented by a rotation prevention function.

15. The bolt according to claim 9, wherein the expanding member is configured arranged in the truncated cone-shaped space of the bolt main body and so that rotation of the shaft relative to the bolt main body is prevented by a rotation prevention function.

16. The bolt according to claim 10, wherein the expanding member is configured arranged in the truncated cone-shaped space of the bolt main body and so that rotation of the shaft relative to the bolt main body is prevented by a rotation prevention function.

17. The bolt according to claim 11, wherein the expanding member is configured arranged in the truncated cone-shaped space of the bolt main body and so that rotation of the shaft relative to the bolt main body is prevented by a rotation prevention function.

18. The bolt according to claim 8, wherein a slit is provided in the expanding member.

19. The bolt according to claim 9, wherein a slit is provided in the expanding member.

20. The bolt according to claim 10, wherein a slit is provided in the expanding member.

21. The bolt according to claim 18, wherein a slit provided in the expanding member is formed with the same slit width over a predetermined length from the distal end of the notch and with a width of the base (terminating part) of the slit broader than the slit width.

22. The bolt according to claim 11, wherein a slit is provided in the expanding member.

23. The bolt according to claim 22, wherein a slit provided in the expanding member is formed with the same slit width over a predetermined length from the distal end of the notch and with a width of the base (terminating part) of the slit broader than the slit width.
